(19) United States
(12) Patent Application Publication
(10) Pub. No.: US 2020/0279004 A1
(43) Pub. Date: Sep. 3, 2020

(54) BUILDING LINEAGES OF DOCUMENTS

(71) Applicant: FoundFusion Inc., Woodinville, WA (US)

(72) Inventors: Steve Serdy, Seattle, WA (US); Keith Rowe, Seattle, WA (US); Dean Lester, Seattle, WA (US)

(21) Appl. No.: 16/805,534

(22) Filed: Feb. 28, 2020

Related U.S. Application Data
(60) Provisional application No. 62/811,723, filed on Feb. 28, 2019.
(60) Provisional application No. 62/828,316, filed on Apr. 2, 2019.

(51) Int. Cl. G06F 16/93; G06F 16/908; G06F 16/906

(52) U.S. Cl. CPC G06F 16/93; G06F 16/906; G06F 16/908

(57) ABSTRACT

A system for organizing a collection of documents from multiple sources, identifying which are different versions of the same content, and using metadata from those documents to provide an ordered collection to display the iterations as a lineage. For text-based documents the system determines which documents are different versions of the same using content analysis techniques. For non-text-based documents, a different mechanism based on file names is performed that detects common conventions for iterating on file names.

### CROSS-REFERENCE TO RELATED APPLICATIONS

This patent application claims the benefit of and priority to U.S. Provisional Patent Application Ser. No. 62/811,723, filed Feb. 28, 2019 and entitled “BUILDING LINEAGES OF EMAIL ATTACHMENTS,” and to U.S. Provisional Patent Application Ser. No. 62/828,316, filed Apr. 2, 2019 and entitled “BUILDING LINEAGES OF DOCUMENTS,” the disclosures of which are hereby incorporated by reference in their entirety.

### BACKGROUND

Documents such as word-processed text documents, spreadsheets or slide presentations are developed and evolve through a series of changes, either by the original author or through collaboration with other parties who make their own changes. Folders on the user's system may have many different versions of the same document with similar or differing file names making it hard to understand the lineage of the document and to identify if a user is working on the most recent version of a document. Additionally, users commonly take actions like renaming documents (for example, adding a “-Johns Edits”, customer identifiers, etc.) that can make searches for these documents difficult and prevent users from finding all iterations of a document. In some scenarios, parties convert an editable document to non-editable before sharing that document with another party like a customer, client, or other user outside their organization to ensure all metadata is removed from the working copy.

Most of the time a document goes through several revisions before it is finalized and is ready to share with coworkers, clients, customers, etc. At places like law firms and corporations, for example, multiple users are oftentimes involved with revising a document, thus creating multiple different versions of the document. Additionally, some users may rename documents by adding some type of identifier to the end of the document name (e.g., v1.0, Bills_edits, etc.).

In order to maintain version control of a document, many law firms and corporations have a document management system such as ClearQuest®/ClearCase®, Dropbox®, SharePoint®, etc. These document management systems allow users to check out a document if they are going to revise it, add comments to it, etc. In these conventional types of document management systems, only one user at a time can check out a document and make changes to it. Therefore, multiple versions of the same document are not being revised at the same time and only the most current version of the document can be revised. This type of checkout system can be inefficient and requires a remote platform to operate.

Problems arise when there is no version control of a document. When documents are emailed to users and revisions are made on multiple users' local machines, conventional systems or platforms have no way to keep track of who is revising a document and when it is being revised. Therefore, multiple users may be making changes to the same document at the same time, thus creating two different versions of an original document. When this happens, there is no “master” document, and it is difficult to know if all of the revisions to the document from all of the users are being incorporated into one “master” document. Because of this, some changes to the document may not be incorporated into the final version of the document, which may result in critical information missing from the document, frustration of the contributing parties, and a generally lower quality work product. Currently, the only way to remedy this problem is to manually look through each version of the document and make sure all changes to the document are incorporated into the final version of the document. This manual process is extremely time consuming and inefficient. Alternatively, document comparisons of difference versions can provide some insight into differences in documents, but often fails entirely or is incomplete in identifying a full scope of changes that are substantial and complex in multiple document versions.

The art would benefit from a clear, efficient, and accurate document comparison technique.

### BRIEF DESCRIPTION OF THE DRAWINGS

FIG. 1 shows an example process of how documents are compared in a system.

FIG. 2 shows an example process used to group documents into similarity groups.

FIG. 3 shows an example process to determine a similarity group for a text-based document.

FIG. 4 shows an example process used to assign a similarity group based on a file name.

FIG. 5 shows an example process used to retrieve a document's lineage.

### DETAILED DESCRIPTION

Users would benefit by a solution that made it easy to see all the versions of a document, organized in such a way that made it clear which version had the most recent changes. This would save the user time and reduce mistakes by ensuring the right version was updated, shared, or archived. The present disclosure makes it possible to leverage document analysis to present the user with a tool that makes it easy to find documents within their mailbox, local computer, or network location to see the relationship between various versions of a document, and determine what changes have been made between each version of the document.

In the disclosed systems, devices and methods, such a collection of similar documents is referred to as a “lineage.” A lineage for a document includes all of the versions of a particular document. The different versions of the document can include edits and comments from others that were received via email and different file names or formats for the different versions of the document.

In order to track these lineages, the disclosed system creates a new piece of metadata for each document, which is called its “similarity group.” Each document that belongs to the same lineage has the same similarity group identification. The main action of the system is to classify documents into these similarity groups, and then use that analysis to present lineage information.

Determining if a document belongs to a particular similarity group can be accomplished using multiple strategies depending on the type of the file. First, changes made to a file name can be detected by comparing both file names and determining if there is some number of characters in common. For example, a title comparison of two documents different by its prefix or suffix, such as when a user adds “V2” to indicate a “version two” or “Johns changes” to indicate the user that made the changes to the document. Alternatively, some document formats (for example, Microsoft Office® documents) have properties embedded in the file that contain the document title, original author, etc. that may be used to determine if multiple documents are the same or likely to be the same but have different file name(s). For example, a Microsoft Office documents have a title property for documents. By default, this is set to the name a file is originally saved as, but can also be set by the user. If a file is renamed and changed, this title property is often unchanged from the original version, and can be used to determine that the renamed version is part of the original document linage.

Additionally, by performing content analysis on two or more documents with techniques such as Minhashing and Jaccard Similarity, the content of the documents can be scored to determine how similar they are. The Minhashing technique provides a mechanism quickly estimate how similar two sets of data are by breaking a document into a collection of substrings known as a shingle, calculate a hash value for every shingle to convert the substring into a number, then storing the minimum value of all the hash values. By repeating this with a set of different hash functions, a signature is built using the minimum hash value from all the hash functions applied to the document. Comparing the MinHash signatures is done using the Jaccard Similarity technique, which calculates similarity by measuring the intersection of similar parts of the signatures over the union of the size of both signatures, i.e.

$$J ( X , Y ) = \frac{\vert X ⋂ Y \vert}{\vert X ⋃ Y \vert}$$

For documents with high similarity, the system described in the present disclosure makes assumptions that these are different versions of the same document, and thus belong to the same similarity group

Showing the user the lineage of a document from a single source (email or local computer folder) is useful. The solution becomes even more powerful when the disclosed document similarity techniques are used to look for the same document across multiple locations thereby providing the user a more complete view of a document's history.

For data security, privacy, and other reasons, data for users may be obtained from one or more remote servers, the present invention can run on local (end user) machines and not on one or more the remote servers themselves. By doing this, only the end user's data (e.g., email, attachments, documents, etc.) is accessed and analyzed in order to ensure the security and privacy of other users' data. The disclosed system can alternatively adapt to operate as a cloud-based service or other remotely accessed service that communicates with various remote end user devices, as one in the skill in the art could envision.

The system described in the present disclosure may leverage sync API's such as Exchange Web Services (EWS) or an API appropriate to the mail server to synchronize messages from the Exchange Server into a local database on the end user's device.

The system also monitors a list of local computer folders designated by the user that contain documents they wish included, along with network locations such as Drobox® for documents which are added or changed.

Once new and modified documents have been identified, the system identifies the similarity group for the identified documents. In order to determine the similarity group for each unique document, it is necessary to determine the similarity between documents in order to determine if they are different versions of the same document. Detecting similar documents starts by examining the file type and file name. When comparing file types, assumptions are made that some content can easily be saved as different file types (e.g., text can be saved in a .txt file, Microsoft Word file, or PDF file), but others cannot (e.g., an image can be saved as a .png file, but not a .txt file). The algorithm can group file types into families, for example:

| Family | File Extensions |
|---|---|
| Document | .docx, .doc, .pdf, .txt |
| Image | .bmp, .png, .jpg, .jpeg, .tiff |
| Presentation | .ppt, .pptx |
| Spreadsheet | .xls, .xlsx |

This list can be modified as the list of file types the application supports grows.

For file types which are unknown to the system, or their format is unknown, similarity is determined by analyzing the file names to look for overlapping strings. For example, if a common substring is found and that substring is greater than 50% of the overall file name (or any other standard, threshold value, or set of criteria), it is possible the document may be the same. In this example, “file.txt” and “file2.txt” is considered the same document, as would “2019 Annual Projections.xlsx” and “2019 Annual Projections—Steve Comments.xls.” However, “2018 Annual Report.xlsx” and “2018 Annual Business Goals.docx” are not considered the same document. The 50% threshold may need to be tuned depending on the particular application, industry, organization, or other criteria and can be customized, if desired. Also, this threshold may depend on the overall file name length in which smaller names have a higher threshold and longer names have a lower threshold. The solution described here uses a Levenshtein distance algorithm to efficiently compare the similarity of two file names by measuring the number of differences between two strings. For example, the Levenshtein distance between “kitten” and “smitten” is 3. The search is optimized using a q-gram algorithm, which starts by dividing the file name into substrings of a preset length (i.e. 3 characters) and storing each q-gram in a database. For example, “file.txt” gets saved as “fil, ile, le., e.t, .tx, txt”. When a new file is ingested, instead of computing the Levenshtein distance between new file and all existing files, the algorithm can reduce the number of comparisons by only examining existing files that have overlapping q-grams, and further reducing comparisons by only examining files that have a high number of overlapping q-grams (i.e. 50%).

When a new document has a file name that is considered similar to a document filename already classified in the system, it is given the same similarity group as the existing document. If no such document is discovered, a new similarity group is created, and the new document receives that similarity group identification.

For documents whose content is primarily text, content analysis can be performed to look for similarity. One way to do this is to use a technique called Minhashing (see above) to compute a set of hash values for each document, sometimes called the document's “minhash signature”. The system will then apply a Jaccard Similarity test (see above) to determine how similar the signatures are. Minhash signatures are then grouped using Locality-Sensitive Hashing (LSH) (see above) to optimize finding similar minhash signatures without having to compare against every existing minhash signature in the database. This technique also comes from Stanford and is described in the same document referenced above. The LSH technique starts by grouping the minhash values for a signature into bands, i.e. minhash values 0-5 could be band 1, 6-10 band 2, etc. When trying to find similar signatures, instead of applying the Jaccard similarity test to every signature already computed, the first step is to find signatures that have at least one matching set of values in a particular LSH band. When a new document is added, the algorithm looks for existing documents that have at least one band of the signature that matches the new document. If a match is found, the new document signature is compared to the entire signature of the matching document with the Jaccard similarity test. If it is within the threshold, the new document is given the same similarity group as the matching document.

Each such text-based similarity group has a single minhash signature. This single signature is called the “exemplar” and is selected from among all the document signatures in the similarity group. The exemplar minhash signature for a similarity group is the signature that has the lowest average Jacquard Similarity to all other members of the similarity group. This is also called the “k-medoid” of the group. As new documents are added to a similarity group, the exemplar for the similarity group may change.

For some classes of documents, the content of two documents can be mostly the same, but small significant changes such as names, addresses, or monetary values, can indicate the document should not be added to an existing similarity group. The application uses machine learning for named entity recognition to identify and classify these entities. If the documents have similar minhash signatures, but the document entities are different, the system places the documents in separate similarity groups. An example of this might be a rental agreement. Most of the agreement is boilerplate legal content, but the name, address, and rent amount might be different. In this case, since most of the content matches other rental agreements, the new document would be treated as part of the same similarity group with all other rental agreement by default, but by looking at the named entities we can assign this document into a new similarity group as a new document.

Other techniques for content analysis within a document family are also envisioned.

When a request is made for the lineage of a document, the system loads the similarity group containing that document and determines using Jaccard Similarity or Levenshtein distance between the selected document and all other documents in the similarity group. The documents in the similarity group that match a threshold are ordered according to user preference and displayed as the document lineage.

### FIGURES

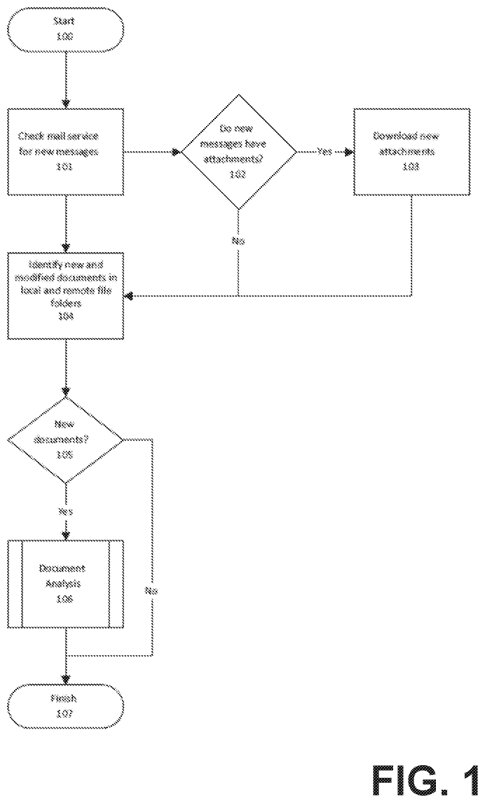

FIG. 1 depicts an overview of how documents are ingested into the system. The method may be facilitated by a processor that is located within a client device (e.g., computer) or is running as a service on a remote system, such as a cloud-based service. The client device may support execution of the application described in this disclosure. It should be appreciated that at least a portion of the functionalities of the method may be performed by a server that may be in communication with the client device.

The method can use a number of software applications or routines stored in a program memory of the client/user device and may obtain data from the data storage of the client/user device. The applications or routines may form modules when implemented by the processor of the client/user device, and each module may implement part or all of the method described below.

The method of FIG. 1 begins (100) when the system looks for new documents to ingest. For example, if Microsoft Exchange® is the email server, the system will request new messages from the server. If there are new email messages (e.g., one or more email messages are marked as “unread”) then the system will download message details for the new messages (101).

The method continues when the system determines whether the new messages have any attachments or not (102). If the email message has no attachments, then the system returns to synchronizing more email messages. If the email message does have attachments, then the system downloads all the attachments for that message and saves the attachments to the document store (103).

The method continues by examining folders for new and changed documents (104). Documents which are new have an entry added to the document store, and documents which appear changed have their previous similarity group in the store deleted (105).

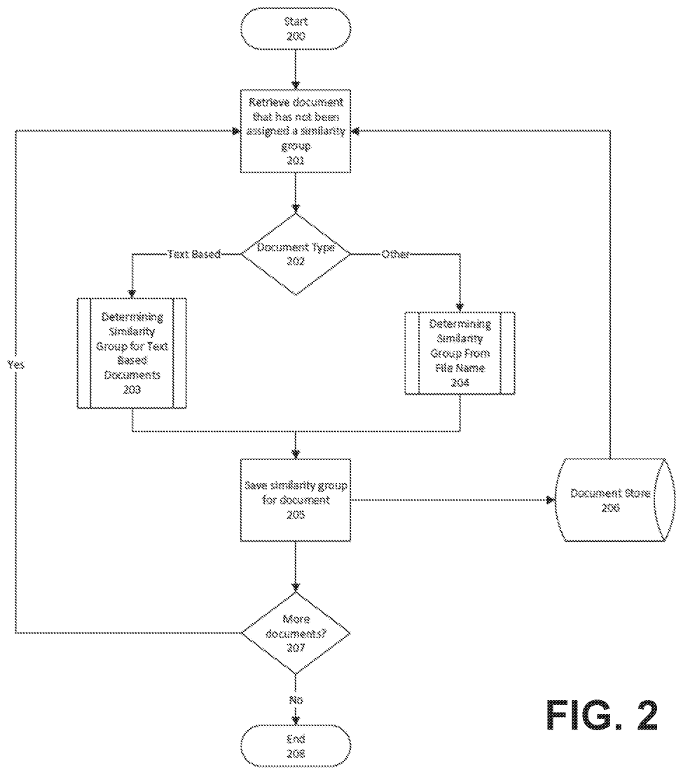

Once new documents are identified, the document analysis process is performed to build up the metadata necessary to identify similarity groups for the new documents (106, FIG. 2).

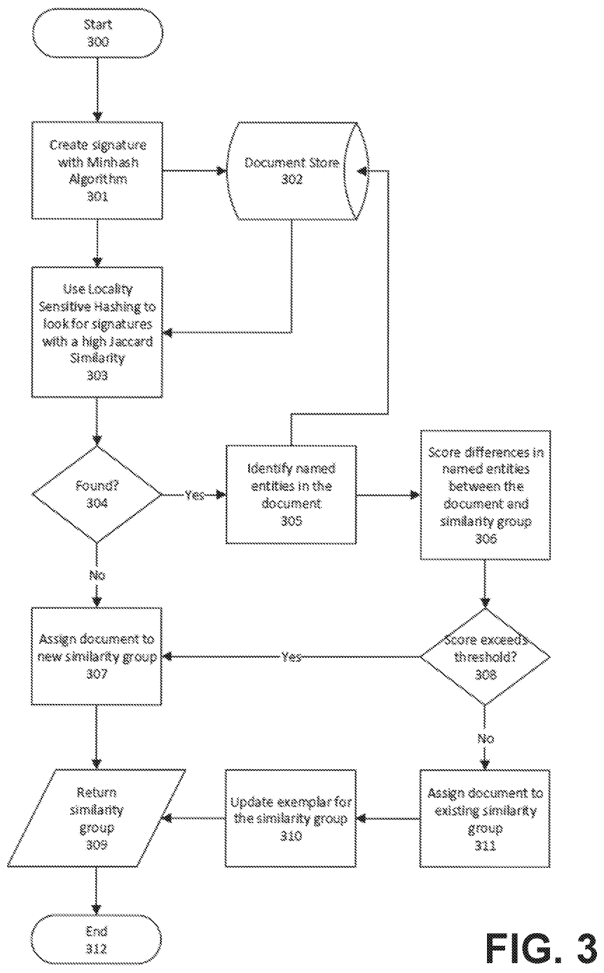

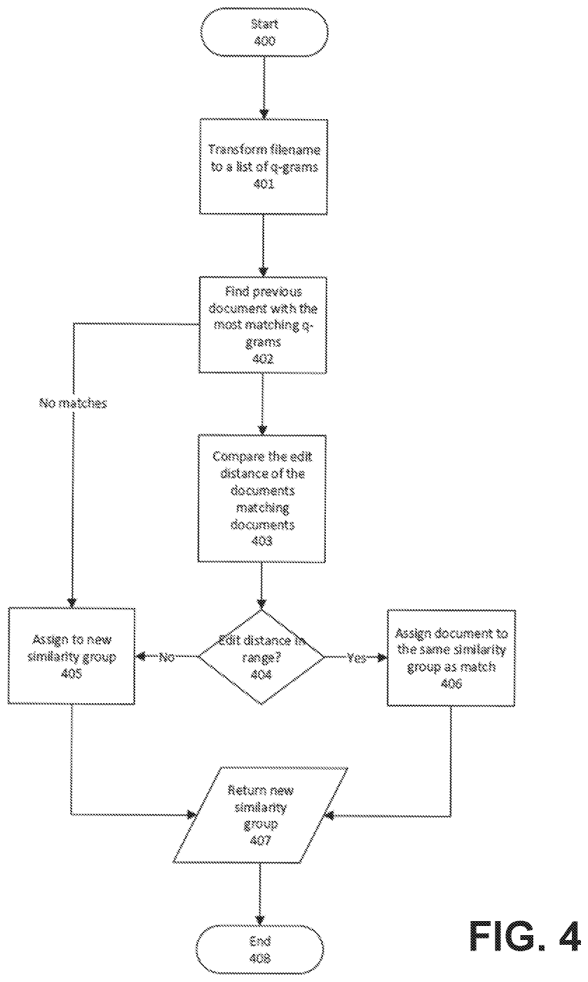

FIG. 2 shows the process used to group documents into similarity groups (200). The process starts by identifying a document which has not yet been assigned a similarity group (201). The type of the document determines the process used to assign a similarity group (202). Documents which are primarily text will use a content analysis to determine the similarity group (203, FIG. 3), and other document types will be grouped using an analysis of their file names (204, FIG. 4).

Other processes for assigning similarity groups for different file types are envisioned.

Once a document has been assigned to a similarity group (205), that information is saved in the document store (206) and the next document without a similarity group is analyzed (207).

FIG. 3 details the process for determining a similarity group for a text based document (300). The process starts by using Minhashing (mentioned above) to develop a signature for the document content (301). The calculated signature is saved to the document store for later use (302).

The method continues by using Locality-Sensitive Hashing (mentioned above) to look for similarity group exemplar minhash signatures in the document store that have a high Jaccard Similarity score (303). If such a similarity group is found (304), it is the proposed similarity group for the document. If no such similarity group is found, a new similarity group is created, and the new document is assigned to it (307).

If there is a proposed similarity group, a Named Entity Recognizer (mentioned above) is used to determine the key entities within the document (305), and are saved in the document store associated with this document (302).

The entities are compared against the proposed similarity group identified previously (306), and if the differences exceed a threshold (308), the document is assigned to a new similarity group (307). Otherwise, the document is assigned to the proposed similarity group (311).

Once the similarity group has been assigned, that value is returned to the calling algorithm (309).

While the difference between two versions of a document might be small, the differences between the first draft and the final draft might be quite large, so as each new document is added to a similarity group, a new exemplar is identified (311). The new exemplar is identified as the document in the similarity group with the lowest average Jaccard similarities to all the other documents in the similarity group.

FIG. 4 describes the process used to assign a similarity group based on a file name. The process starts (400) by transforming the file name of the document into a collection of overlapping substrings called q-grams (401). For example, a document named “Picture.peg” would become (“Pic”, “ict”, “ctu”, “tur”, “ure”, “re.”, “e.j”, “.jp”, “jpe”, “peg”).

The method continues by identifying all existing documents that q-grams in their file name which match the q-grams from the new document (402). For each matching document, an edit-distance is calculated using the Levenshtein distance (403), and if a distance exceeds a defined threshold (404), the new document is assigned to the same similarity group (406).

If no matching documents are found in the list of q-grams, or none of the documents have a Levenshtein distance which exceeds the defined threshold, the new document is assigned to a new similarity group (405).

Once the similarity group has been assigned, that value is returned to the calling algorithm (407).

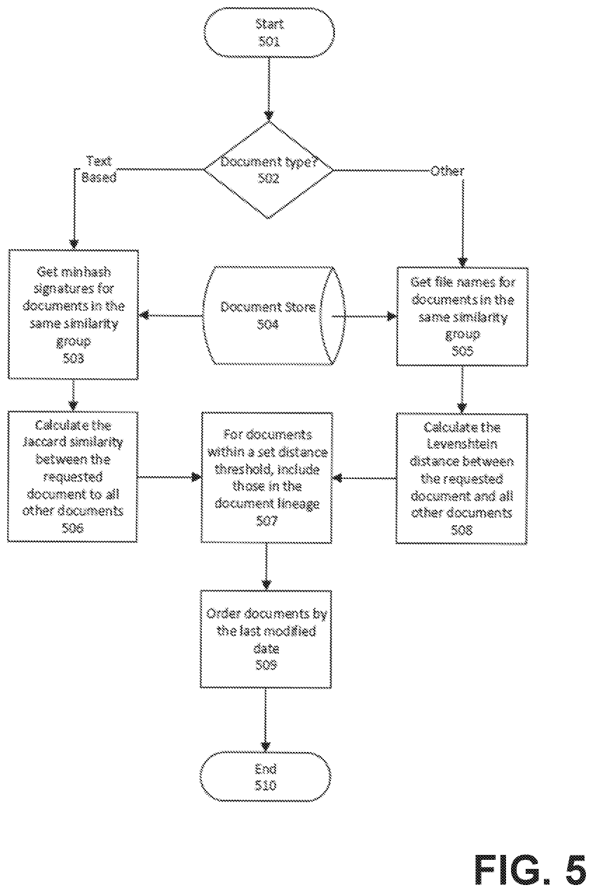

FIG. 5 shows the process used to retrieve a document's lineage. The method starts (501) determining the document type (502).

If the document is text based, all of the Minhash signatures for the same similarity group are retrieved (503) from the document store (504). The process then computes the Jaccard similarity between the Minhash signature of the requested document and the Minhash signatures of the other documents in the similarity group (506).

If the document is not text based, all of the file names for documents in the same similarity group are retrieved (505) from the document store (504). The process then computes the Levenshtein distance between the requested document's file name and all of the other file names in the similarity group (508).

The method continues by taking the documents whose distance meets or exceeds a defined threshold and includes those documents in the lineage (509), then orders those documents by last modified date (509). The last modified date can be determined in multiple ways—either the last saved date from the file system, properties saved in the document, attributes of the document such as date information saved with reviewing comments, or the date a document was downloaded from the email service.

The method completes by returning the ordered list of documents (510).

The method may use a number of software applications or routines stored in a program memory of the client device and may obtain data from the data storage of the client device. The applications or routines may form modules when implemented by the processor of the client device, and each module may implement part or all of the method described below.

The client device may include one or more processors adapted and configured to execute various software applications and components of the system, in addition to other software applications. The client device may further include a database, such as a mail store and/or message database, which may be adapted to store data related to the system, such as emails, attachments, and documents. The client device may access data stored in the database. The client device may have a controller that is operatively connected to the database. It should be noted that, while not shown, additional databases may be linked to the controller in a manner known to those of skill in the art. The controller may include a program memory, a processor, a RAM, and an I/O circuit, all of which may be interconnected via an address/data bus. It should be appreciated that although only one microprocessor is shown, the controller may include multiple microprocessors. Similarly, the memory of the controller may include multiple RAMs and multiple program memories. Although the I/O circuit is shown as a single block, it should be appreciated that the I/O circuit may include a number of different types of I/O circuits. The RAM and program memories may be implemented as semiconductor memories, magnetically readable memories, or optically readable memories, for example.

The client device may further include a number of software applications or routines stored in a program memory. These applications or routines may form modules when implemented by the processor, and each module may implement part or all of the methods described in the present disclosure. Such modules may include an application user interface (UI), lineage manager, and document comparator as described above with respect to FIG. 3.

When the controller (or other processor) generates information for the user, the information may be presented to the user of the client device using a display or other output component of the client device. User input may likewise be received via an input of the client device. Thus, the client device may include various input and output components, units, or devices. The display and speaker, along with other integrated or communicatively connected output devices (not shown), may be used to present information to the user of the client device or others. The display may include any known or hereafter developed visual or tactile display technology, including LCD, OLED, AMOLED, projection displays, refreshable braille displays, haptic displays, or other types of displays. The one or more speakers may similarly include any controllable audible output device or component, which may include a haptic component or device. In some embodiments, communicatively connected speakers may be used (e.g., headphones, Bluetooth headsets, docking stations with additional speakers, etc.). The input may further receive information from the user. Such input may include a physical or virtual keyboard, a microphone, virtual or physical buttons or dials, or other means of receiving information. In some embodiments, the display may include a touch screen or otherwise be configured to receive input from a user, in which case the display and the input may be combined.

The client device may also communicate with a server or other components via the network. Such communication may involve the communication unit, which may manage communication between the controller and external devices (e.g., network components of the network, etc.). The communication unit may further transmit and receive wired or wireless communications with external devices, using any suitable wireless communication protocol network, such as a wireless telephony network (e.g., GSM, CDMA, LTE, etc.), a Wi-Fi network (802.11 standards), a WiMAX network, a Bluetooth network, etc. Additionally, or alternatively, the communication unit may also be capable of communicating using a near field communication standard (e.g., ISO/IEC 18092, standards provided by the NFC Forum, etc.). Furthermore, the communication unit may provide input signals to the controller via the I/O circuit. The communication unit may also transmit device status information, control signals, or other output from the controller to the server or other devices via the network.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be used for realizing the invention in diverse forms thereof.

1. A document lineage system configured to:
a processor configured to:
receive electronic data representing a collection of documents;
identify multiple documents in the collection that have a group document property, the group document property including content of the document;
group the identified documents based each having the group document property that includes content of the document;
generate a signature for each of the documents in the group, each signature representative of content in each respective document;
compare the signature for each of the documents in the group to determine a percentage of overlap of content between each of the documents in the group;
generate a score for each comparison that correlates with a relative value for the percentage of overlap of content between each of the documents;
identify comparisons for which the score is above a predetermined threshold value;
cluster the documents associated with the scores that are above the predetermined threshold value into a first cluster;
generate a first document lineage for the first cluster, the first document lineage representing a relationship between each of the documents in the first cluster based on relative scores;
for the documents in the collection of documents that do not have the group document property, compare a difference in filenames between the documents to determine a percentage of overlap score between each of the documents;
cluster the documents in the collection that do not have the group document property into a second cluster;
determine a document lineage for the collection of documents based on the score for the two or more of the documents that is above the predetermined threshold value;
generate a second document lineage for the second cluster, the second document lineage representing a relationship between each of the documents in the second cluster based on the comparison of the filenames; and
an output configured to output the first document lineage and the second document lineage.

2. The system of claim 1, wherein the group document property is a document type associated with each document.

3. The system of claim 1, wherein the group document property is a document family associated with each document.

4. The system of claim 1, wherein the processor is further configured to generate the signature using a MinHashing technique.

5. The system of claim 4, wherein the processor is further configured to compare the signature for each of the multiples of documents to determine a percentage of overlap of content between all of the multiples of documents using a Jaccard Similarity technique.

6. The system of claim 4, wherein the processor is further configured to cluster the documents based on the signature before the score is generated for each document.

7. The system of claim 6, wherein the processor is further configured to group the documents using a Locality-Sensitive Hashing (LSH) technique.

8. The system of claim 7, wherein the processor is further configured to identify sub-groups within the groups of documents, each sub-group identified based on a sub-group property of the document that is different from the group property of the document used to group the collection of documents.

9. The system of claim 1, wherein the output is a user interface.

10. The system of claim 9, wherein the user interface includes one or multiples of a display, an audio output, or a tactile output.

11. The system of claim 1, wherein the documents include attachments to electronic mail messages.

12. The system of claim 1, wherein the documents include data files stored on one or more of a server, computer network, or computer system.

13. The system of claim 12, wherein the one or more of the server, computer network, or computer system are configured to be accessible by multiple users.

14. A document lineage system, comprising:
a processor configured to:
group multiple text-based document files based on a group document property of each of the documents;
using a MinHashing technique, generate a file signature unique to each of the text-based document files, the file signature representing a user-readable content of the document;
using a Jaccard similarity technique, compare the file signatures for each of the document files to identify a percentage of overlap of content between multiples of the document files;
generate a score for each comparison based on the percentage of overlap of content between multiples of the text-based document files;
determine the score for two or more of the text-based documents is above a predetermined threshold;
determine that the score for two or more of the text-based documents is above a predetermined threshold;
generate a document lineage for the multiple text-based document files based on the score for the multiple text-based documents that are above the predetermined threshold;
group non-text-based documents;
generate a score for each of the non-text-based documents based on the Levenshtein distance between filenames of each of the non-text-based documents;
determine that the score for the non-text-based documents is above a threshold for non-text-based documents; and
generate a document lineage for the multiple non-text-based document files based on the score for the multiple non-text-based documents that are above the predetermined threshold; and
an output configured to output the document lineage for the text-based documents and the document lineage for the non-text-based documents.

15. The system of claim 14, wherein the group document property is a document type associated with each of the document files.

16. The system of claim 14, wherein the group document property is a document family associated with each of the document files.

17. The system of claim 14, wherein the processor is further configured to identify a sub-group within the group of multiple document files, each sub-group identified based on a sub-group property of the document that is different from the group document property of the document used to group the document files.

18. The system of claim 14, wherein the output is a user interface.

19. The system of claim 18, wherein the user interface includes one or multiples of a display, an audio output, or a tactile output.

20. The system of claim 14, wherein the document files include data files stored on one or more of a server, computer network, or computer system configured to be accessible by multiple users.
